(19) United States
(12) Patent Application Publication
(10) Pub. No.: US 2023/0385480 A1
(43) Pub. Date: Nov. 30, 2023

(54) METHOD FOR OBTAINING MILLING PARTICLE GRADATION PREDICTION MODEL, PREDICTION METHOD AND DEVICE

(71) Applicants: JIANGSU XCMG CONSTRUCTION MACHINERY RESEARCH INSTITUTE LTD., Xuzhou (CN); XUZHOU XUGONG ROAD CONSTRUCTION MACHINERY CO., LTD, Xuzhou (CN)

(72) Inventors: Bing HE, Xuzhou (CN); Haibo JIA, Xuzhou (CN); Kaixuan KANG, Xuzhou (CN); Hongwei SHA, Xuzhou (CN)

(21) Appl. No.: 18/130,155

(22) Filed: Apr. 3, 2023

(30) Foreign Application Priority Data
May 30, 2022 (CN) 202210601885.5

(51) Int. Cl. G06F 30/20; E01C 23/06

(52) U.S. Cl. CPC G06F 30/20; E01C 23/065; G06F 2111/10

(57) ABSTRACT

The present disclosure provides a method for obtaining a milling particle gradation prediction model, a prediction method and a device. The method includes: sieving a plurality of groups of test particles obtained by a plurality of milling tests to obtain a sieve residual mass ratio corresponding to each of a plurality of sieves after performing milling tests on an asphalt layer; calculating a characteristic parameter of a cutting graph of the milling rotor according to arrangement of cutter teeth of the milling rotor, a rotational speed, a forward speed, and a milling depth of the milling rotor; establishing, by regression analysis, a functional relation between the sieve residual mass ratio corresponding to each sieve and the characteristic parameter according to the rotational speed, the forward speed and the milling depth; and normalizing the functional relation to obtain the milling particle gradation prediction model.

### CROSS-REFERENCE TO RELATED APPLICATIONS

The present application is based on and claims priority to Chinese patent application No. 202210601885.5 filed on May 30, 2022, the disclosure of which is incorporated by reference herein in its entirety.

### TECHNICAL FIELD

The present disclosure relates to the technical field of road pavement maintenance and construction, and in particular to a method for obtaining a milling particle gradation prediction model, a prediction method, and a device.

### BACKGROUND

An in-situ cold recycling technique is a technique that can realize the recycling of an old asphalt pavement in a process comprising steps of in-situ milling of an asphalt layer using special equipment, mixing, at room temperature, a certain amount of new minerals, recycled binding materials and water, and then paving and compaction. In the in-situ cold recycling technology, the old material obtained from the asphalt pavement by means of milling and excavation is the recycled asphalt pavement material.

Gradation is the distribution of particles at all levels of aggregates, which can be determined by sieve test. Gradation calculation method comprises: (1) individual sub-count sieve residual percentage: mass percentage, to a total sample mass, of sieve residues corresponding to a specific sieve size; (2) cumulative sub-count sieve residual percentage: sum of an individual sub-count sieve residual percentage corresponding to a specific sieve size and sub-count sieve residual percentages corresponding to sieve sizes greater than the specific sieve size; (3) passing percentage: mass percentage, to a total sample mass, of grains passing a sieve of a specific sieve size.

At present, the refurbishment and reuse of old pavement has become a key task of pavement maintenance work. The asphalt recycling process comprises an in-situ cold recycling process and a full-deep cold recycling process. One of the requirements for in-situ cold recycling construction of the asphalt layer is that the recycled asphalt particles meet a certain gradation combination.

### SUMMARY

According to an aspect of the present disclosure, a method for obtaining a milling particle gradation prediction model is provided. The method comprises: sieving a plurality of groups of test particles obtained by a plurality of milling tests to obtain a sieve residual mass ratio corresponding to each of a plurality of sieves after performing the plurality of milling tests on an asphalt layer under a plurality of sets of test conditions, wherein each set of the plurality of sets of test conditions comprises: a rotational speed, a forward speed and a milling depth of a milling rotor of an in-situ cold recycling apparatus, the plurality of sieves having different aperture sizes; calculating a characteristic parameter of a cutting graph of the milling rotor according to arrangement of cutter teeth of the milling rotor, the rotational speed, the forward speed, and the milling depth; establishing, by regression analysis, a functional relation between the sieve residual mass ratio corresponding to the each of the plurality of sieves obtained through a milling test and the characteristic parameter of the cutting graph of the milling rotor according to the rotational speed, the forward speed and the milling depth, wherein the sieve residual mass ratio corresponding to the each of the plurality of sieves is a function of the characteristic parameter of the cutting graph of the milling rotor; and normalizing the functional relation to obtain the milling particle gradation prediction model.

In some embodiments, the calculating of the characteristic parameter of the cutting graph of the milling rotor according to the arrangement of the cutter teeth of the milling rotor, the rotational speed, the forward speed, and the milling depth comprises: calculating a position of an xth cutter tooth of the milling rotor when the xth cutter tooth cuts to a maximum milling thickness according to the arrangement of the cutter tooth of the milling rotor, the rotational speed, the forward speed and the milling depth, wherein x is a positive integer and x >1; calculating an equation expression of a caving line corresponding to the xth cutter tooth according to the position of the xth cutter tooth of the milling rotor when the xth cutter tooth cuts to the maximum milling thickness and a caving angle of the xth cutter tooth when milling the asphalt layer, to obtain equation expressions of caving lines corresponding to a plurality of cutter teeth of the milling rotor, the plurality of cutter teeth comprising the xth cutter tooth; and calculating a characteristic parameter of a cutting unit pattern corresponding to the xth cutter tooth as the characteristic parameter of the cutting graph of the milling rotor according to the equation expressions of the caving lines corresponding to the plurality of cutter teeth of the milling rotor and the cutting graph of the milling rotor.

In some embodiments, coordinates of the position of the xth cutter tooth of the milling rotor when the xth cutter tooth cuts to the maximum milling thickness are (Lₓ, Pₓ),wherein Lₓ is an abscissa of the xth cutter tooth in the cutting graph in a direction parallel to an axis of the milling rotor, which is a known quantity, Pₓ is an ordinate of the xth cutter tooth in the cutting graph in a direction perpendicular to the axis of the milling rotor,

$${P}_{x} = ( \frac{{c}_{x}}{360} + m ) \frac{v}{n} sin ( θ ) ,$$

wherein

$$θ = arc cos \frac{R - H}{R} ,$$

wherein Cₓ is a circumferential angle of the xth cutter tooth, v is the forward speed of the milling rotor, n is the rotational speed of the milling rotor, H is the milling depth, R is a milling radius of the milling rotor, and m is a number of an integer revolution that the xth cutter tooth has rotated, m≤0 and m is an integer.

In some embodiments, the calculating of the characteristic parameter of the cutting unit pattern corresponding to the xth cutter tooth according to the equation expressions of the caving lines corresponding to the plurality of cutter teeth of the milling rotor and the cutting graph of the milling rotor comprises: obtaining equation expressions of a plurality of edges of the cutting unit pattern corresponding to the xth cutter tooth according to the equation expressions of the caving lines corresponding to the plurality of cutter teeth of the milling rotor; calculating position coordinates of a plurality of vertices of the cutting unit pattern corresponding to the xth cutter tooth according to the equation expressions of the plurality of edges of the cutting unit pattern corresponding to the xth cutter tooth; and calculating the characteristic parameter of the cutting unit pattern corresponding to the xth cutter tooth according to the position coordinates of the plurality of vertices.

In some embodiments, the characteristic parameter of the cutting unit pattern corresponding to the xth cutter tooth comprises: a length of a hypotenuse of a right triangle constructed inside the cutting unit pattern with one edge of the cutting unit pattern as a right angle edge in accordance with a predetermined composition method.

In some embodiments, the functional relation between the sieve residual mass ratio corresponding to the each of the plurality of sieves and the characteristic parameter of the cutting graph of the milling rotor is: F_{φ}=A_{φ}(τ)³+B_{φ}(τ)2+C_{φ}(τ)+D_{φ}, wherein F_{φ} is the sieve residual mass ratio of a sieve φ, τ is the characteristic parameter of the cutting graph of the milling rotor, and A_{φ}, B_{φ}, C_{φ} and D_{φ} are coefficients.

In some embodiments, the normalizing of the functional relation comprises: calculating a theoretical value of the sieve residual mass ratio corresponding to each of the plurality of sieves according to the characteristic parameter of the cutting graph of the milling rotor and the functional relation; calculating a sum of theoretical values of sieve residual mass ratios corresponding to the plurality of sieves according to the theoretical value of the sieve residual mass ratio corresponding to the each of the plurality of sieves; and normalizing the functional relation by using the sum of the theoretical values of the sieve residual mass ratios corresponding to the plurality of sieves.

In some embodiments, the milling rotor comprises: a roller; and multiple rows of cutter teeth spirally disposed on the roller, wherein the cutter teeth are arranged on the milling rotor in such a way that: the multiple rows of cutter teeth comprise a plurality of cutter tooth sets arranged in a direction of an axial of the roller, wherein each of the plurality of cutter tooth sets comprises a first cutter tooth, a second cutter tooth and a third cutter tooth, the first cutter tooth, the second cutter tooth and the third cutter tooth being disposed in different rows of the multiple rows of cutter teeth, a projection of the second cutter tooth on the axis of the roller being between a projection of the first cutter tooth on the axis of the roller and a projection of the third cutter tooth on the axis of the roller, and a difference between a circumferential angle of the third cutter tooth and a circumferential angle of the first cutter tooth being less than a difference between a circumferential angle of the second cutter tooth and the circumferential angle of the first cutter tooth.

In some embodiments, in a process of milling the asphalt layer by the milling rotor, the asphalt layer is cut in an order of the first cutter tooth, the third cutter tooth and the second cutter tooth.

According to another aspect of the present disclosure, a method for predicting recycled particle gradation is provided. The method comprises: inputting a condition parameter to a milling particle gradation prediction model, wherein the milling particle gradation prediction model is obtained by the method described above; and calculating a sieve residual mass ratio corresponding to each sieve using the milling particle gradation prediction model and according to the condition parameter.

In some embodiments, the condition parameter comprises the rotational speed of the milling rotor and the forward speed of the milling rotor.

In some embodiments, the condition parameter further comprises the milling depth.

According to another aspect of the present disclosure, a device for obtaining a milling particle gradation prediction model is provided. The device comprises: a milling test unit configured to sieve a plurality of groups of test particles obtained by a plurality of milling tests to obtain a sieve residual mass ratio corresponding to each of a plurality of sieves after performing the plurality of milling tests on an asphalt layer under a plurality of sets of test conditions, wherein each set of the plurality of sets of test conditions comprises: a rotational speed, a forward speed and a milling depth of a milling rotor of an in-situ cold recycling apparatus, the plurality of sieves having different aperture sizes; a calculation unit configured to calculate a characteristic parameter of a cutting graph of the milling rotor according to arrangement of cutter teeth of the milling rotor, the rotational speed, the forward speed, and the milling depth; a regression analysis unit configured to establish, by regression analysis, a functional relation between the sieve residual mass ratio corresponding to the each of the plurality of sieves obtained through a milling test and the characteristic parameter of the cutting graph of the milling rotor according to the rotational speed, the forward speed and the milling depth, wherein the sieve residual mass ratio corresponding to the each of the plurality of sieves is a function of the characteristic parameter of the cutting graph of the milling rotor; and a normalization unit configured to normalize the functional relation to obtain the milling particle gradation prediction model.

According to another aspect of the present disclosure, a device for obtaining a milling particle gradation prediction model is provided. The device comprises: a memory; and a processor coupled to the memory, the processor being configured to, according to instructions stored in the memory, carry out the method described above.

According to another aspect of the present disclosure, a device for predicting recycled particle gradation is provided.

The device comprises: an input module configured to input a condition parameter to a milling particle gradation prediction model, wherein the milling particle gradation prediction model is obtained by the method described above; and a calculation module configured to calculate a sieve residual mass ratio corresponding to each sieve using the milling particle gradation prediction model and according to the condition parameter.

According to another aspect of the present disclosure, a device for predicting recycled particle gradation is provided. The device comprises: a memory; and a processor coupled to the memory, the processor being configured to, according to instructions stored in the memory, carry out the method described above.

According to another aspect of the present disclosure, a milling rotor for an in-situ cold recycling apparatus is provided. The milling rotor comprises: a roller; and multiple rows of cutter teeth spirally disposed on the roller, the multiple rows of cutter teeth comprising a plurality of cutter tooth sets arranged in a direction of an axial of the roller; wherein each of the plurality of cutter tooth sets comprises a first cutter tooth, a second cutter tooth and a third cutter tooth, the first cutter tooth, the second cutter tooth and the third cutter tooth being disposed in different rows of the multiple rows of cutter teeth, a projection of the second cutter tooth on the axis of the roller being between a projection of the first cutter tooth on the axis of the roller and a projection of the third cutter tooth on the axis of the roller, and a difference between a circumferential angle of the third cutter tooth and a circumferential angle of the first cutter tooth being less than a difference between a circumferential angle of the second cutter tooth and the circumferential angle of the first cutter tooth.

In some embodiments, in a process of milling an asphalt layer by the milling rotor, the asphalt layer is cut in an order of the first cutter tooth, the third cutter tooth and the second cutter tooth.

In some embodiments, a distance between adjacent cutter teeth in the direction of the axial of the roller is in a range of 16 millimeters to 22 millimeters.

According to another aspect of the present disclosure, an in-situ cold recycling apparatus is provided. The in-situ cold recycling apparatus comprises the device for predicting the recycled particle gradation described above.

According to another aspect of the present disclosure, an in-situ cold recycling apparatus is provided. The in-situ cold recycling apparatus comprises the milling rotor for the in-situ cold recycling apparatus described above.

According to another aspect of the present disclosure, there is provided a non-transitory computer-readable storage medium having computer program instructions stored thereon that, when executed by a processor, implement the method described above.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 is a schematic diagram illustrating a three-dimensional structure of a milling rotor for an in-situ cold recycling apparatus according to an embodiment of the present disclosure;

FIG. 2 is a schematic expanded diagram illustrating arrangement of cutter teeth of a milling rotor for an in-situ cold recycling apparatus according to an embodiment of the present disclosure;

FIG. 3 is a schematic diagram illustrating a circumferential angle of cutter teeth of a milling rotor according to some embodiments of the present disclosure;

FIG. 4 is a flowchart illustrating a method for obtaining a milling particle gradation prediction model according to an embodiment of the present disclosure;

FIG. 5 is a schematic diagram illustrating a cutting graph of cutter teeth of a milling rotor according to an embodiment of the present disclosure;

FIG. 6 is a schematic diagram illustrating milling of a cutter tooth of a milling rotor according to an embodiment of the present disclosure;

FIG. 7 is a schematic diagram illustrating a cutting unit pattern according to an embodiment of the present disclosure;

FIG. 8 is a flowchart illustrating a method for predicting recycled particle gradation according to an embodiment of the present disclosure;

FIG. 9 is a block diagram illustrating a structure of a device for obtaining a milling particle gradation prediction model according to an embodiment of the present disclosure;

FIG. 10 is a block diagram illustrating a structure of a device for obtaining a milling particle gradation prediction model according to another embodiment of the present disclosure;

FIG. 11 is a block diagram illustrating a structure of a device for obtaining a milling particle gradation prediction model according to still another embodiment of the present disclosure;

FIG. 12 is a block diagram illustrating a structure of a device for predicting recycled particle gradation according to an embodiment of the present disclosure;

FIG. 13 is a block diagram illustrating a structure of a device for predicting recycled particle gradation according to another embodiment of the present disclosure.

### DETAILED DESCRIPTION

Various exemplary embodiments of the present disclosure will now be described in detail with reference to the accompanying drawings. Notice that, unless otherwise specified, the relative arrangement of the components and steps, numerical expressions and values set forth in these examples do not limit the scope of the disclosure.

At the same time, it should be understood that, for ease of description, the dimensions of the various parts shown in the drawings are not drawn to actual proportions.

The following description of at least one exemplary embodiment is in fact merely illustrative and is in no way intended as a limitation to the disclosure, its application or use.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters indicate similar items in the accompanying drawings below, and therefore, once an item is defined in a drawing, there is no need for further discussion in the accompanying drawings.

In the relevant art, recycling tests can be conducted on road segments to analyze the recycled particle gradation. This often requires recycling tests on a plurality road segments to determine a combination of operational parameters that meet the construction requirements, which may lead to tedious operational tasks and a long time of test, and in turn a long time of construction. In addition, the above process can lead to problems such as waste of asphalt material.

In view of this, an embodiment of the present disclosure provides a method for obtaining a milling particle gradation prediction model in order to facilitate the prediction of recycled particle gradation and reduce construction time.

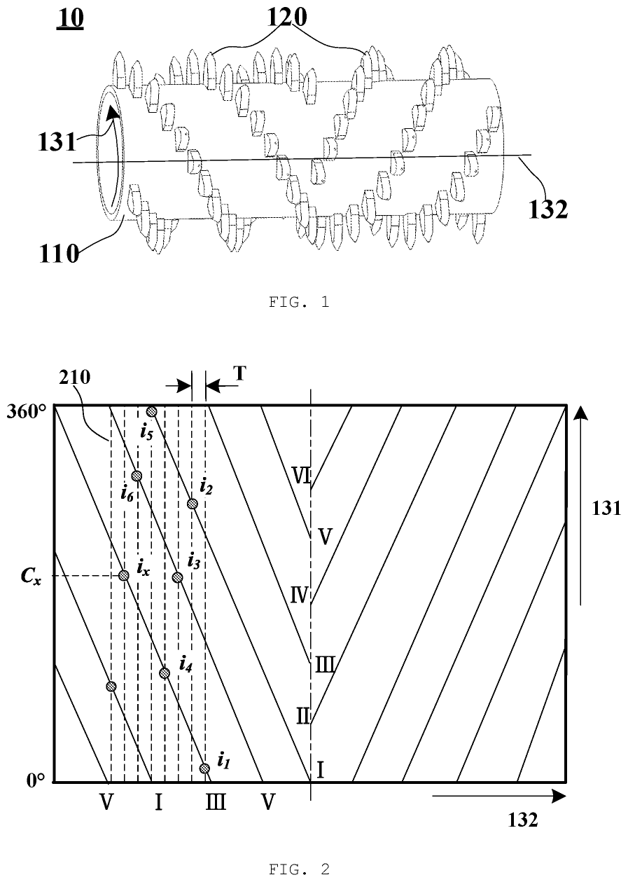

FIG. 1 is a schematic diagram illustrating a three-dimensional structure of a milling rotor for an in-situ cold recycling apparatus according to an embodiment of the present disclosure. As shown in FIG. 1, the milling rotor 10 comprises a roller 110 and multiple rows of cutter teeth 120 spirally disposed on the roller 110. For example, the roller is a cylindrical roller. FIG. 1 also shows a circumferential direction 131 of the roller (i.e., a circumferential direction of the milling rotor) and an a direction of an axial 132 of the roller (i.e., an axial direction of the milling rotor). For example, the above milling rotor can be used for the implementation of in-situ cold recycling of an asphalt layer (e.g., an asphalt pavement).

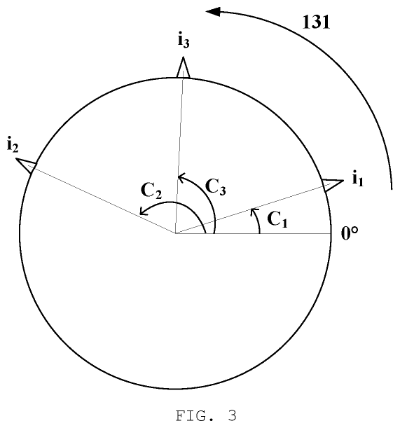

FIG. 2 is a schematic expanded diagram illustrating arrangement of cutter teeth of a milling rotor for an in-situ cold recycling apparatus according to an embodiment of the present disclosure. FIG. 2 is a diagram of tooth arrangement obtained by expanding the three-dimensional view of FIG. 1 along the circumferential direction 131 of the roller. Also shown in FIG. 2 is a circumferential angle Cₓ of the cutter tooth, which ranges from 0° to 360°.

Multiple rows, for example, rows I to VI of teeth are shown in FIG. 2. Each row of teeth has a plurality of teeth. FIG. 2 illustratively shows cutter teeth i₁, i₂, i₃, 1₄, i₅, i₆ . . . ix . . . (i.e., cutter teeth 120 in FIG. 1). The multiple rows of cutter teeth comprise a plurality of cutter tooth sets arranged in a direction (i.e., the axial direction) of an axial 132 of the roller. For example, cutter teeth i₁, i₂ and i₃ form a first cutter tooth set, cutter teeth i₄, i₅ and i₆ form a second cutter tooth set, and so on. The first cutter tooth set, the second cutter tooth set and the like are arranged along the axial direction 132 of the roller.

As shown in FIG. 2, each cutter tooth set comprises a first cutter tooth, a second cutter tooth and a third cutter tooth. With the first cutter tooth set as an example, the first cutter tooth set comprises a first cutter tooth i₁, a second cutter tooth i₂ and a third cutter tooth i₃. The first cutter tooth, the second cutter tooth and the third cutter tooth are disposed in different rows of the multiple rows of cutter teeth. For example, the first cutter tooth i₁ is disposed in row III, the second cutter tooth i₂ is disposed in row I, and the third cutter tooth i₃ is disposed in row V.

A projection of the second cutter tooth on the axis of the roller is between a projection of the first cutter tooth on the axis of the roller and a projection of the third cutter tooth on the axis of the roller. For example, a projection of the second cutter tooth i₂ on the axis 132 of the roller 110 is between a projection of the first cutter tooth i₁ on the axis 132 of the roller 110 and a projection of the third cutter tooth i₃ on the axis 132 of the roller 110.

FIG. 3 is a schematic diagram illustrating a circumferential angle of cutter teeth of a milling rotor according to some embodiments of the present disclosure.

The positioning of a cutter tooth on the roller is achieved by a circumferential angle and an axial position of the cutter tooth. The circumferential angle of the cutter tooth is an angle of the cutter tooth in a circumferential direction of the roller. For example, in a case where a circumferential angle of 0° is arbitrarily set in advance, a radian between a projection of a cutter tooth ix on a circular bottom surface of a cylindrical roller and a projection of the 0° position on the circular bottom surface is a circumferential angle Cₓ of the cutter tooth iₓ. For example, FIG. 3 shows a circumferential angle C₁ of a cutter tooth i₁, a circumferential angle C₂ of a cutter tooth i₂, and a circumferential angle C₃ of a cutter tooth i₃.

In embodiments of the present disclosure, in each cutter tooth set, a difference between the circumferential angle of the third cutter tooth and the circumferential angle of the first cutter tooth is less than a difference between the circumferential angle of the second cutter tooth and the circumferential angle of the first cutter tooth. For example, as shown in FIG. 3, a difference (i.e., C₃-C₁) between the circumferential angle C₃ of the third cutter tooth i₃ and the circumferential angle C₁ of the first cutter tooth i₁ is less than a difference (i.e., C₂-C₁) between the circumferential angle C₂ of the second cutter tooth i₂ and the circumferential angle C₁ of the first cutter tooth ii.

Heretofore, a milling rotor for an in-situ cold recycling apparatus according to some embodiments of the present disclosure is provided. The milling rotor comprises: a roller; and multiple rows of cutter teeth spirally disposed on the roller, the multiple rows of cutter teeth comprising a plurality of cutter tooth sets arranged in a direction of an axial of the roller; wherein each of the plurality of cutter tooth sets comprises a first cutter tooth, a second cutter tooth and a third cutter tooth, the first cutter tooth, the second cutter tooth and the third cutter tooth being disposed in different rows of the multiple rows of cutter teeth, a projection of the second cutter tooth on the axis of the roller being between a projection of the first cutter tooth on the axis of the roller and a projection of the third cutter tooth on the axis of the roller, and a difference between a circumferential angle of the third cutter tooth and a circumferential angle of the first cutter tooth being less than a difference between a circumferential angle of the second cutter tooth and the circumferential angle of the first cutter tooth. When milling an asphalt layer (e.g., an asphalt pavement) using the milling rotor, uniform and square particles can be obtained, which can facilitate the implementation of the in-situ cold recycling process.

During the process of milling the asphalt layer (e.g., the asphalt pavement) using the above milling rotor, the asphalt layer can be cut into in the order of the first cutter tooth, the third cutter tooth, and the second cutter tooth.

In the tooth arrangement of the above milling rotor, adjacent teeth in the axial direction of the milling rotor are disposed in a “skipped” feed arrangement. An analysis will be taken with a set of cutter teeth comprising three adjacent teeth (e.g., cutter tooth i₁, cutter tooth i₂, and cutter tooth i₃) in the axial direction as an example, the cutter tooth i₁ first cuts into the road surface, then the cutter tooth i₃, which is separated from the cutter tooth i₁ by a generatrix (that is, an dotted line perpendicular to the axial direction in FIG. 2) 210, cuts into the road surface, and then the cutter tooth i₂ adjacent to the cutter tooth i₁ cuts into the road surface. Cutter teeth i₄, i₅, i₆ and other cutter teeth on the milling rotor are also disposed in this “skipped” feed arrangement.

In some embodiments, as shown in FIG. 2, a distance T between adjacent cutter teeth in the direction (i.e., the axial direction) of the axial of the roller is in a range of 16 millimeters (mm) to 22 millimeters. For example, the distance T between the cutter tooth i₁ and the cutter tooth i₂ is in a range of 16 millimeters to 22 millimeters. This distance design, together with the “skipped” arrangement of the teeth, allows a nearly square cutting pattern of the teeth under certain pavement recycling conditions (e.g., a milling depth of 10 centimeters (cm) to 20 centimeters and a forward speed of 3 m/min (meters per minute) to 6 m/min), which is conducive to obtaining particles with uniform shape and aggregates with a wider grading range, so as to meet the requirements of in-situ cold recycling construction of asphalt layers.

In some embodiments, as shown in FIG. 1, the multiple rows of cutter teeth are spirally disposed toward a middle portion of the rotor. Milling particles generally need to be collected and transported during asphalt pavement milling construction operations. The cutter teeth are wound (i.e., spirally disposed) toward the middle portion of the rotor to collect the milling particles toward the middle portion. A throwing opening is provided at a location of the milling machine corresponding to the middle portion of the rotor, so that the particles can be easily thrown out and transported.

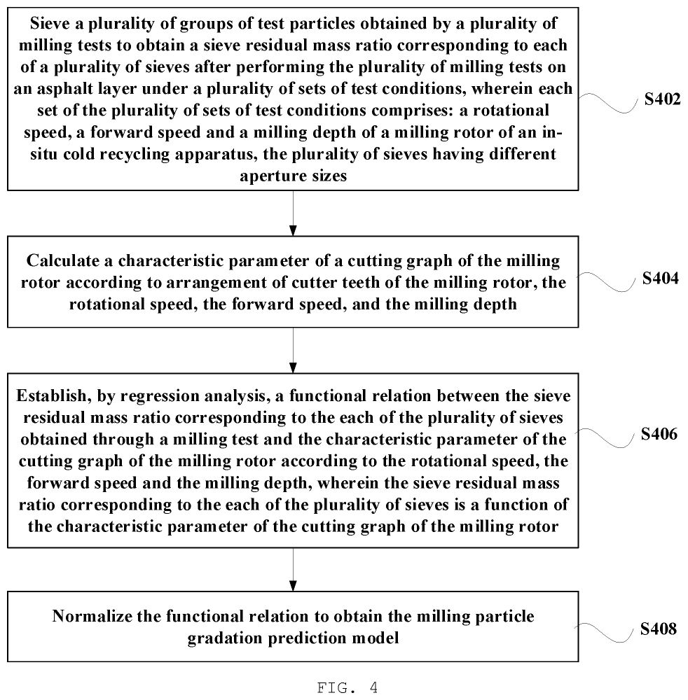

FIG. 4 is a flowchart illustrating a method for obtaining a milling particle gradation prediction model according to an embodiment of the present disclosure. As shown in FIG. 4, the method comprises steps S402 to S408.

In step S402, a plurality of groups of test particles obtained by a plurality of milling tests are sieved to obtain a sieve residual mass ratio corresponding to each of a plurality of sieves after performing the plurality of milling tests on an asphalt layer under a plurality of sets of test conditions, wherein each set of the plurality of sets of test conditions comprises: a rotational speed, a forward speed and a milling depth of a milling rotor of an in-situ cold recycling apparatus, the plurality of sieves having different aperture sizes (or grain sizes). For example, the asphalt layer is an asphalt pavement.

Here, three-factor multilevel orthogonal milling tests are conducted on the asphalt layer according to the tooth arrangement of the milling rotor, and different level values of the rotational speed, forward speed and milling depth of the milling rotor, etc. Particles produced in the milling tests are collected and sieved, and sieve residual mass ratios (i.e., mass ratios of particles of various sizes) corresponding to different sieves are calculated to obtain recycled particle gradations for different combinations of the operating parameters.

In some embodiments, the sieve residual mass ratio is a sub-count sieve residual percentage. The sub-count sieve residual percentage is a percentage of a sieve residual mass on a sieve to a total mass of a sample.

Table 1 is a table of exemplary asphalt pavement milling tests. In the Table 1, there are five groups (1 #to 5 #) of test conditions. In each group of test conditions, a rotational speed, a forward speed and a milling depth of a milling rotor are specified.

TABLE 1
Asphalt pavement milling tests

| | Milling | Rotational speed of | Forward |
|---|---|---|---|
| | depth | Milling rotor | speed |
| Test No. | (mm) | (r/min) | (m/min) |
| 1# | 100 | 80 | 3 |
| 2# | 100 | 100 | 4.5 |
| 3# | 100 | 120 | 6 |
| 4# | 150 | 80 | 4.5 |
| 5# | 150 | 100 | 6 |

Table 2 is a table of exemplary particle sieving tests. In the Table 2, sieves having seven aperture sizes are shown, each sieve filtering a test particle corresponding one size.

TABLE 2
Particle sieving tests

| Sieving | Sieve residual mass ratio (%) for each sieve aperture size (mm) | | | | | | |
|---|---|---|---|---|---|---|---|
| test | 19 | 16 | 13.2 | 9.5 | 4.75 | 1.18 | <1.18 |
| No. | mm | mm | mm | mm | mm | mm | mm |
| 1# | 6 | 6 | 9 | 20 | 30 | 25 | 4 |
| 2# | 0.5 | 1.5 | 5 | 13 | 34 | 40 | 6 |
| 3# | 1 | 2 | 5 | 23 | 40 | 27 | 2 |
| 4# | 4 | 9 | 12 | 22 | 34 | 17 | 2 |
| 5# | 2 | 7 | 11 | 28 | 33 | 16 | 3 |

For example, under test condition #1 (a milling depth of 100 mm, a milling rotor rotational speed of 80 r/min (revolutions per minute), and a forward speed of 3 m/min), particles obtained from the test are sieved to obtain the following sieve residual mass ratios in Table 2: a sieve residual mass ratio of 6% for the sieve with an aperture size of 19 mm, a sieve residual mass ratio of 6% for the sieve with an aperture size of 16 mm, a sieve residual mass ratio of 9% for the sieve with an aperture size of 13.2 mm, a sieve residual mass ratio of 20% for the sieve with an aperture size of 9.5 mm, a sieve residual mass ratio of 30% for the sieve with an aperture size of 4.75 mm, a sieve residual mass ratio of 25% for the sieve with an aperture size of 1.18 mm, a sieve residual mass ratio of 4% for the sieve with an aperture size less than 1.18 mm.

It should be noted that the data in Tables 1 and 2 above are exemplary, and the scope of the present disclosure is not limited thereto.

In step S404, a characteristic parameter of a cutting graph of the milling rotor is calculated according to arrangement of cutter teeth of the milling rotor, the rotational speed, the forward speed, and the milling depth.

Here, the cutting graph is theoretically drawn on the assumption that the milling rotor rotates more than one revolution, and reflects marks left on a plane where a maximum milling thickness is located when the milling rotor mills to the maximum milling thickness.

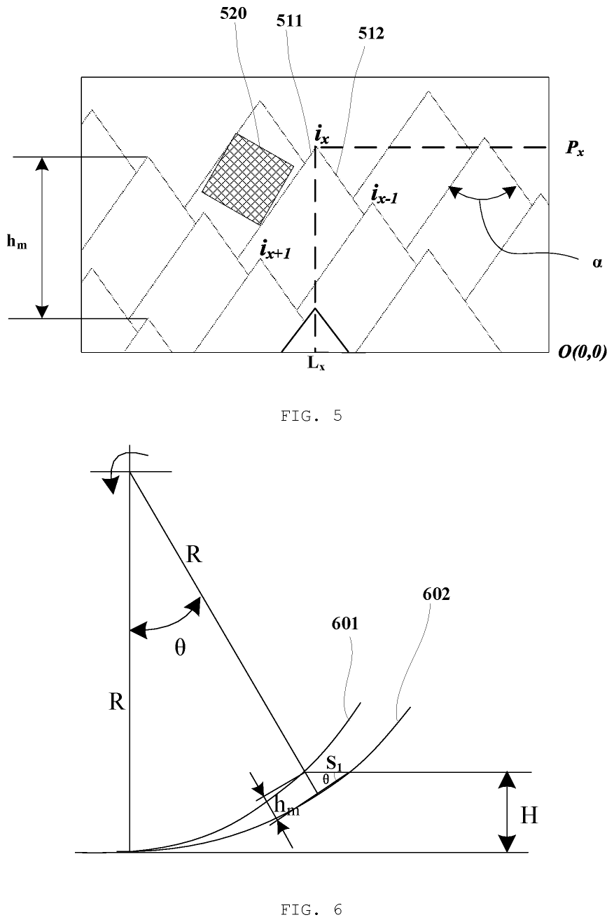

FIG. 5 is a schematic diagram illustrating a cutting graph of cutter teeth of a milling rotor according to an embodiment of the present disclosure. As shown in FIG. 5, the cutting graph illustrates positions of cutter teeth iₓ₋₁, iₓ, iₓ₊1, etc. Here, x is a positive integer and x >1. Taking the xth cutter tooth iₓ as an example, the position of the xth cutter tooth iₓ on the cutting graph can be represented by coordinates (Lₓ, Pₓ). FIG. 5 also shows a caving angle α corresponding to each cutter tooth. Here, it is assumed that caving angles corresponding to all cutter teeth are substantially equal, which are CE. On both sides of each tooth position, a first caving line 511 and a second caving line 512 are formed respectively. For example, as shown in FIG. 5, the first caving line 511 is on a left side of the tooth position (the first caving line can also be called a left caving line), and the second caving line 512 is on a right side of the tooth position (the second caving line can also be called a right caving line). FIG. 5 also shows a maximum milling thickness hₘ. FIG. 5 also shows a maximum square 520 that can be formed in the cutting graph, wherein the maximum square 520 generally represents a shape of the particles formed during the milling process.

In some embodiments, the step S404 comprises: calculating a position of an xth cutter tooth ixof the milling rotor when the xth cutter tooth cuts to a maximum milling thickness according to the arrangement of the cutter tooth of the milling rotor, the rotational speed, the forward speed and the milling depth, wherein x is a positive integer and x >1.

As described above, coordinates of the position of the xth cutter tooth of the milling rotor when the xth cutter tooth cuts to the maximum milling thickness are (Lₓ, Pₓ). Here, Lₓ is an abscissa of the xth cutter tooth in the cutting graph in a direction parallel to an axis of the milling rotor, which is a known quantity; Pₓ is an ordinate of the xth cutter tooth in the cutting graph in a direction perpendicular to the axis of the milling rotor.

For example,

$${P}_{x} = ( \frac{{C}_{x}}{360} + m ) \frac{v}{n} sin ( θ ) , \qquad ( 1 )$$

wherein

$$θ = arc cos \frac{R - H}{R} , \qquad ( 2 )$$

wherein Cₓ is a circumferential angle of the xth cutter tooth, v is the forward speed of the milling rotor, n is the rotational speed of the milling rotor, H is the milling depth, R is a milling radius of the milling rotor, and m is a number of an integer revolution that the xth cutter tooth has rotated, m 0 and m is an integer. Here, Cₓ, v, n, H, R and m are all known quantities.

FIG. 6 is a schematic diagram illustrating milling of a cutter tooth of a milling rotor according to an embodiment of the present disclosure. The origin of the above equation (1) will be described in detail below with reference to FIG. 5 and FIG. 6.

Since the milling rotor travels forward while rotating during operation, the milling rotor cuts off asphalt material during one revolution, with a gradually increased milling depth. The milling depth when the milling rotor reaches to the maximum depth is the maximum milling thickness. As shown in FIG. 6, the milling rotor rotates along a rotational trajectory line 601 first, and then along a next rotational trajectory line 602 in the process of traveling forward.

In FIG. 6, Si represents a distance the milling rotor travels forward when it rotates one revolution, and

$${S}_{1} = \frac{v}{n} . \qquad ( 3 )$$

In FIG. 6, the maximum milling thickness hₘ is

$${h}_{m} = {S}_{1} * sin ( θ ) = \frac{v}{n} * sin ( θ ) ,$$

$$wherein θ = arc cos \frac{R - H}{R} .$$

In a case where the milling rotor rotates for one revolution, the angle of rotation of the cutter tooth iₓ is Cₓ, so the length of rotation of the cutter tooth iₓ in the circumferential direction in the cutting graph is:

$$\frac{{C}_{x}}{360} * {h}_{m} = \frac{{C}_{x}}{360} * \frac{v}{n} * sin ( θ ) . \qquad ( 4 )$$

In the actual rotation of the milling rotor, the rotor may rotate multiple revolutions, and the cutter tooth iₓ rotates for

$$( \frac{{C}_{x}}{360} + m )$$

revolutions accordingly, so the ordinate Pₓ of the xth cutter tooth iₓ is:

$${P}_{x} = ( \frac{{C}_{x}}{360} + m ) \frac{v}{n} sin ( θ ) . \qquad ( 1 )$$

In this way, the above equation (1) is derived, which in turn gives the coordinates (Lₓ, P_{X}) of the cutter tooth iₓ in the cutting graph.

In some embodiments, the above step S404 further comprises: calculating an equation expression of a caving line corresponding to the xth cutter tooth according to the position of the xth cutter tooth of the milling rotor when the xth cutter tooth cuts to the maximum milling thickness and a caving angle of the xth cutter tooth when milling the asphalt layer (for example, an asphalt pavement), to obtain equation expressions of caving lines corresponding to a plurality of cutter teeth of the milling rotor, the plurality of cutter teeth comprising the xth cutter tooth.

For example, as shown in FIG. 5, a slope of a caving line in the cutting graph can be calculated according to the caving angle. A slope of a first caving line 511 corresponding to the cutter tooth iₓ is

$$tan ( 90 ° - \frac{α}{2} )$$

and a slope of a second caving line 512 corresponding to the cutter tooth iₓ is

$$tan ( 90 ° - \frac{α}{2} ) .$$

According to the calculated coordinates (Lₓ, P_{X}) of the cutter tooth iₓ in the cutting graph and the slope of the first caving line 511, an equation expression of the first caving line 511 corresponding to the xth cutter tooth iₓ can be obtained; and according to the coordinates (Lₓ, Pₓ) of the cutter tooth iₓ in the cutting graph and the slope of the second caving line 512, an equation expression of the second caving line 512 corresponding to the xth cutter tooth iₓ can be obtained.

In addition, equation expressions of caving lines corresponding to other cutter teeth, for example, equation expressions of caving lines of cutter teeth iₓ₋₁, iₓ₊₁, iₓ₊₂, etc., can be obtained by a calculation process similar to the above calculation process.

In some embodiments, the above step S404 further comprises: calculating a characteristic parameter of a cutting unit pattern corresponding to the xth cutter tooth as the characteristic parameter of the cutting graph of the milling rotor according to the equation expressions of the caving lines corresponding to the plurality of cutter teeth of the milling rotor and the cutting graph of the milling rotor.

In some embodiments, the calculating of the characteristic parameter of the cutting unit pattern corresponding to the xth cutter tooth according to the equation expressions of the caving lines corresponding to the plurality of cutter teeth of the milling rotor and the cutting graph of the milling rotor comprises: obtaining equation expressions of a plurality of edges of the cutting unit pattern corresponding to the xth cutter tooth according to the equation expressions of the caving lines corresponding to the plurality of cutter teeth of the milling rotor; calculating position coordinates of a plurality of vertices of the cutting unit pattern corresponding to the xth cutter tooth according to the equation expressions of the plurality of edges of the cutting unit pattern corresponding to the xth cutter tooth; and calculating the characteristic parameter of the cutting unit pattern corresponding to the xth cutter tooth according to the position coordinates of the plurality of vertices.

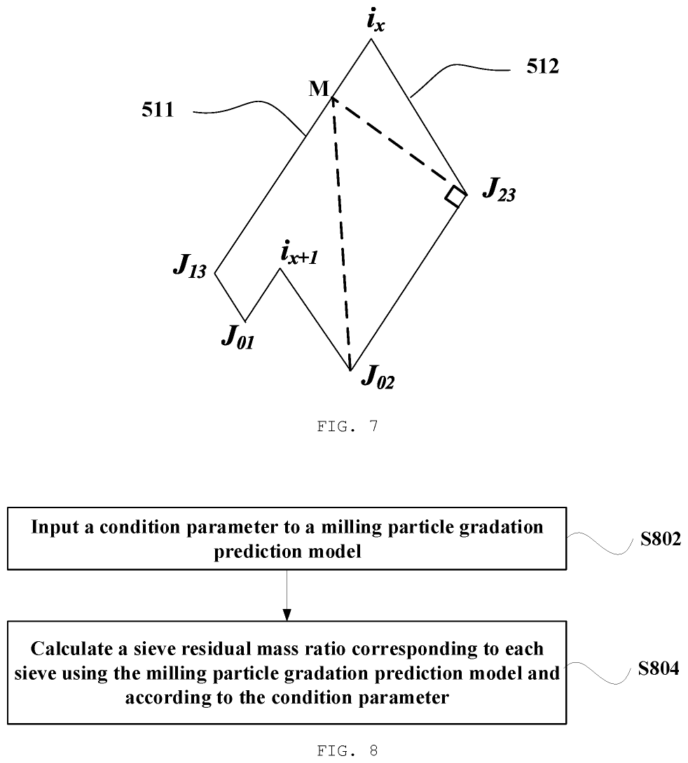

For example, FIG. 7 is a schematic diagram illustrating a cutting unit pattern according to an embodiment of the present disclosure. As shown in FIG. 7, the cutting unit pattern of the cutter tooth iₓ is enclosed by line segments iₓJ₁₃, iₓJ₂₃, J₁₃J₀₁, iₓ₊₁J₀₁, iₓ₊₁J₀₂, and J₂₃J₀₂. These line segments are the edges of the cutting unit pattern. Here, an equation expression of a line where each line segment is located is an equation expression of a caving line corresponding to a corresponding cutter tooth. For example, an equation expression of a line where the line segment iₓJ₁₃ is located is an equation expression of a first caving line corresponding to the cutter tooth iₓ, an equation expression of a line where the line segment iₓJ₂₃ is located is an equation expression of a second caving line corresponding to the cutter tooth iₓ, an equation expression of a line where the line segment J₂₃J₀₂ is located is an equation expression of a first caving line of the cutter tooth iₓ₋₁ (as can be seen from FIG. 5), and an equation expression of a line where line segment iₓ₊₁J₀₂ is located is an equation expression of a second caving line of the cutter tooth iₓ₊₁, an equation expression of a line where the line segment iₓ₊₁J₀₁ is located is an equation expression of a first caving line of the cutter tooth iₓ₊₁, and an equation expression of a line where the line segment J₁₃J₀₁ is located is an equation expression of a second caving line of another cutter tooth (for example, cutter tooth iₓ+₂) (as can be seen from FIG. 5). In this way, the equation expressions of the multiple edges of the cutting unit pattern corresponding to the xth cutter tooth can be obtained from the equation expressions of the caving lines corresponding to the multiple cutter teeth of the milling rotor.

As shown in FIG. 7, each vertex of the cutting unit pattern is an intersection point of two corresponding edges, for example, vertex J₂₃ is an intersection point of edges iₓJ₂₃ and J₂₃J₀₂, vertex J₀₂ is an intersection point of edges iₓ₊₁J₀₂ and J₂₃J₀₂, and so on. Since an intersection point can be determined by two intersecting lines, position coordinates of a corresponding vertex can be calculated from the equation expressions of two intersecting edges. For example, coordinates of the vertex J₂₃ can be calculated from the equation expressions of edges iₓJ₂₃ and J₂₃J₀₂ obtained above, and coordinates of the vertex J₀₂ can be calculated from the equation expressions of edges iₓ₊₁J₀₂ and J₂₃J₀₂ obtained above. Coordinates of other vertices can also be obtained in this way, which will not be repeated here. Therefore, the position coordinates of vertices of the cutting unit pattern corresponding to the xth tooth can be calculated according to the equation expressions of the plurality of edges of the cutting unit pattern corresponding to the xth tooth.

Next, the characteristic parameter of the cutting unit pattern corresponding to the xth cutter tooth is calculated according to the position coordinates of the plurality of vertices.

In some embodiments, the characteristic parameter of the cutting unit pattern corresponding to the xth cutter tooth comprises: a length of a hypotenuse of a right triangle constructed inside the cutting unit pattern with one edge of the cutting unit pattern as a right angle edge in accordance with a predetermined composition method.

For example, as shown in FIG. 7, a right triangle MJ₂₃ J₀₂ is constructed with an edge J₂₃J₀₂ opposite to the caving angle α as a first right angle edge, a perpendicular line MJ₂₃ perpendicular to the first right angle edge J₂₃J₀₂ as a second right angle edge, and an intersection point M between the perpendicular line MJ₂₃ and an edge iₓJ₁₃ opposite to the first right angle edge J₂₃J₀₂ in the cutting unit pattern as a vertex, wherein a length of a hypotenuse MJ₀₂ of the right triangle MJ₂₃J₀₂ is the characteristic parameter of the cutting unit pattern corresponding to the xth cutter tooth. Here, a right triangle is constructed inside the cutting unit pattern with one edge of the cutting unit pattern as a right angle edge in accordance with a predetermined composition method, and a length of a hypotenuse of the right triangle is the characteristic parameter of the cutting unit pattern.

Since the position coordinates of vertices of the cutting unit pattern have been calculated, the length of the hypotenuse of the right triangle can be calculated from the position coordinates of the vertices, and the characteristic parameter of the cutting unit pattern corresponding to the xth tooth can be obtained.

Of course, those skilled in the art can understand that the above characteristic parameter of the cutting unit pattern is only exemplary, and the scope of the present disclosure is not limited thereto. For example, a right triangle can be constructed inside the cutting unit pattern with another edge of the cutting unit pattern as a right angle edge, and the length of the hypotenuse of the right triangle is the characteristic parameter of the cutting unit pattern.

In other embodiments, another structural feature of the cutting unit pattern may also be used as the characteristic parameter of the cutting unit pattern. For example, an area of the cutting unit pattern can be used as the characteristic parameter of the cutting unit pattern, or an area of a certain shape (e.g., a triangle) constructed inside the cutting unit pattern can be used as the characteristic parameter of the cutting unit pattern, and so on, which will not be described in detail herein.

Since the position coordinates of vertices of the cutting unit pattern have been calculated, a characteristic parameter of the above cutting unit pattern can be calculated according to the position coordinates of the vertices, such as the length of the hypotenuse of another right triangle constructed, the area of the cutting unit pattern, or the like.

Thus, in the above steps, positions of cutter teeth are calculated, and then caving lines corresponding to the xth cutter tooth are calculated according to the caving angle α of the asphalt pavement. A calculation framework for calculating the cutting graph of the milling rotor is set up. An algorithm program for drawing a cutting diagram is developed. A cutting graph of a milling rotor is drawn under the same test parameter combination as the test parameter combination used in the asphalt pavement milling test. The characteristic parameter of the cutting graph of the milling rotor is calculated.

In step S406, a functional relation between the sieve residual mass ratio corresponding to the each of the plurality of sieves obtained through a milling test and the characteristic parameter of the cutting graph of the milling rotor is established, by regression analysis, according to the rotational speed, the forward speed and the milling depth, wherein the sieve residual mass ratio corresponding to the each of the plurality of sieves is a function of the characteristic parameter of the cutting graph of the milling rotor.

In the step, according to the parameters of milling depth, rotational speed, and forward speed, milling test data (i.e., the sieve residual mass ratio corresponding to each sieve in step S402) and the characteristic parameter (i.e., the characteristic parameters in step S404) (e.g., shown in Table 3) of the cutting graph of the milling rotor are integrated, and their functional relation, i.e., a mathematical relationship, is established by regression analysis.

If milling tests are carried out according to the five groups of test conditions in Table 1, characteristic parameters of cutting graphs are also calculated according to these five groups of test conditions, i.e. a corresponding group of milling depth, rotational speed and forward speed in Table 1 is used to calculate a characteristic parameter of a corresponding cutting graph. This ensures as much as possible a one-to-one correspondence between the variables used in the milling test and the variables used in the calculation of the characteristic parameter of the cutting graph, facilitating the establishment of a milling particle gradation prediction model.

TABLE 3
integrated milling test data and characteristic parameters of cutting graphs

| | Test parameters | | | | | | | | | | |
|---|---|---|---|---|---|---|---|---|---|---|---|
| | | Rotational | | Cutting | | | | | | | |
| | | speed of | | graph | sieve residual mass ratio (%) for | | | | | | |
| | Milling | Milling | Forward | Length of | each sieve aperture size (mm) | | | | | | |
| Test | depth | rotor | speed | hypotenuse | 19 | 16 | 13.2 | 9.5 | 4.75 | 1.18 | <1.18 |
| No. | (mm) | (r/min) | (m/min) | (mm) | mm | mm | mm | mm | mm | mm | mm |
| 1# | 100 | 80 | 3 | 25 | 6 | 6 | 9 | 20 | 30 | 25 | 4 |
| 2# | 100 | 100 | 4.5 | 28 | 0.5 | 1.5 | 5 | 13 | 34 | 40 | 6 |
| 3# | 100 | 120 | 6 | 30 | 1 | 2 | 5 | 23 | 40 | 27 | 2 |
| 4# | 150 | 80 | 4.5 | 27 | 4 | 9 | 12 | 22 | 34 | 17 | 2 |
| 5# | 150 | 100 | 6 | 32 | 2 | 7 | 11 | 28 | 33 | 16 | 3 |

In some embodiments, the functional relation between the sieve residual mass ratio corresponding to the each of the plurality of sieves and the characteristic parameter of the cutting graph of the milling rotor is:

F_{φ}=A_{φ}(τ)³+B_{φ}(τ)²+C_{φ}(τ)+D_{φ}, (5)

wherein F_{φ} is the sieve residual mass ratio of a sieve φ, τ is the characteristic parameter of the cutting graph of the milling rotor, and A_{φ}, B_{φ}, C_{φ} and D_{φ} are coefficients. The coefficients A_{φ}, B_{φ}C_{φ} and D_{φ} can be determined from multiple groups of test data (e.g., as shown in Table 3).

For example, by integrating the data corresponding to the sieve residual mass ratio corresponding to each sieve and the cutting graph characteristic parameters of the milling rotor (e.g., shown in Table 3), a functional relation between the sieve residual mass ratio corresponding to each sieve and the characteristic parameter of the cutting graph of the milling rotor can be obtained by polynomial fitting. The more data and the stronger the regularity, the more obvious the mathematical relationship will be.

In step S408, the functional relation is normalized to obtain the milling particle gradation prediction model.

In some embodiments, the step S408 comprises: calculating a theoretical value of the sieve residual mass ratio corresponding to each of the plurality of sieves according to the characteristic parameter of the cutting graph of the milling rotor and the functional relation; calculating a sum of theoretical values of sieve residual mass ratios corresponding to the plurality of sieves according to the theoretical value of the sieve residual mass ratio corresponding to the each of the plurality of sieves; and normalizing the functional relation by using the sum of the theoretical values of the sieve residual mass ratios corresponding to the plurality of sieves.

Here, after establishing the above functional relation by regression analysis, a theoretical value of the sieve residual mass ratio corresponding to each of the plurality of sieves is calculated by substituting the characteristic parameter of the cutting graph of the milling rotor into the functional relation. A sum of theoretical values of the sieve residual mass ratios corresponding to all sieves is calculated, wherein the sum perhaps is not equal to 100%. In such a case, the functional relation is normalized by using the above sum. That is, the normalization of the functional relation is achieved by dividing the polynomial of the functional relation equation (5) by the sum. For example, if the sum is calculated to be 1.01, the normalization of the functional relation is achieved by dividing A_{φ}(τ)³+B_{φ}(τ)²+C_{φ}(τ)+D_{φ} of the functional relation equation (5) by 1.01.

By normalizing all the functional relations, it is possible to make the sum of the sieve residual mass ratios corresponding to various sieve aperture sizes 100% as far as possible, making the prediction of the milling particle gradation prediction model more accurate.

Heretofore, a method for obtaining a milling particle gradation prediction model according to some embodiments of the present disclosure is provided. The method comprises: sieving a plurality of groups of test particles obtained by a plurality of milling tests to obtain a sieve residual mass ratio corresponding to each of a plurality of sieves after performing the plurality of milling tests on an asphalt layer under a plurality of sets of test conditions, wherein each set of the plurality of sets of test conditions comprises: a rotational speed, a forward speed and a milling depth of a milling rotor of an in-situ cold recycling apparatus, the plurality of sieves having different aperture sizes; calculating a characteristic parameter of a cutting graph of the milling rotor according to arrangement of cutter teeth of the milling rotor, the rotational speed, the forward speed, and the milling depth; establishing, by regression analysis, a functional relation between the sieve residual mass ratio corresponding to the each of the plurality of sieves from a milling test and the characteristic parameter of the cutting graph of the milling rotor according to the rotational speed, the forward speed and the milling depth, wherein the sieve residual mass ratio corresponding to the each of the plurality of sieves is a function of the characteristic parameter of the cutting graph of the milling rotor; and normalizing the functional relation to obtain the milling particle gradation prediction model. By obtaining the milling particle gradation prediction model, prediction of particle gradation can be easily achieved for pavement recycled material under different construction parameters, thereby solving as much as possible the problem existed in the related art that operation parameters can be determined by repeated tests on different road segments for in-situ cold recycling construction of an asphalt layer, so that a lot of manpower and material resources can be saved and the construction time can be shortened. In addition, the method may prevent, as far as possible, problems such as waste of asphalt layer material.

In the above embodiment of the present disclosure, by conducting three-factor (i.e., the milling depth, the rotational speed, and the forward speed) multilevel orthogonal milling tests on the asphalt layer (e.g., the asphalt pavement), a database of the relationship between the combination of operational parameters and recycled particle gradation is obtained, thereby avoiding in-situ milling tests for pavement recycling construction; in conjunction with a cutting graph calculation method, a milling particle gradation prediction model for of the asphalt layer is established to achieve prediction of pavement recycled material gradation under different construction parameters, which may solve as much as possible the problem that, for each pavement recycling construction, the test need be conducted on the road segment to determine its operation parameters, so that a lot of manpower and material resources can be saved, and the construction time can be shortened.

FIG. 8 is a flowchart illustrating a method for predicting recycled particle gradation according to an embodiment of the present disclosure. As shown in FIG. 8, the method comprises steps S802 to S804.

In step S802, a condition parameter is input to a milling particle gradation prediction model. The milling particle gradation prediction model can be obtained by the method described above (e.g., the method shown in FIG. 4).

In some embodiments, the condition parameters comprise: a rotational speed of a milling rotor and a forward speed of a milling rotor. Here, in a case where the milling depth is a fixed value (e.g., the milling depth can be pre-set in the model), the condition parameter input to the milling particle gradation prediction model comprises the rotational speed of the milling rotor and the forward speed of the milling rotor. For example, the rotational speed of the milling rotor is in a range of 80 r/min to 120 r/min. The rotational speed can be adjusted within the range. For example, the forward speed is in a range of 3 m/min to 6 m/min. The forward speed can be adjusted within the range. Of course, the scope of the present disclosure is not limited thereto.

In some embodiments, the condition parameter further comprise a milling depth. That i₅, in a case where the milling depth is not a fixed value, the condition parameters comprise the rotational speed of the milling rotor, the forward speed of the milling rotor, and the milling depth. These three condition parameters are input into the milling particle gradation prediction model.

In step S804, a sieve residual mass ratio corresponding to each sieve is calculated using the milling particle gradation prediction model and according to the condition parameter.

Here, after inputting the condition parameter into the milling particle gradation prediction model, the milling particle gradation prediction model calculates a characteristic parameter of a corresponding cutting graph, and then calculates a sieve residual mass ratio corresponding to each sieve according to the functional relation (5).

Heretofore, a method for predicting recycled particle gradation according to some embodiments of the present disclosure is provided. The method comprises: inputting a condition parameter to a milling particle gradation prediction model, wherein the milling particle gradation prediction model is obtained by the method described above; and calculating a sieve residual mass ratio corresponding to each sieve using the milling particle gradation prediction model and according to the condition parameter. The method can achieve the gradation prediction of recycled pavement material under different construction parameters, so that manpower and material resources required in the related technology can be saved and the construction time can be shortened. In addition, the method may prevent, as much as possible, problems such as waste of asphalt layer material.

For example, in the prediction of in-situ cold recycled material gradation for an asphalt pavement, for a specific in-situ cold recycling construction project of an asphalt pavement, the milling depth is generally determined by the specific pavement structure, the rotational speed of the milling rotor and the forward speed of the milling rotor are adjustable. Different combinations of rotational speed and forward speed parameters are set during the in-place cold recycled construction. The characteristic parameter of a cutting graph is calculated with a corresponding combination of operation parameters, and sieve residual mass ratios of sieves having different aperture sizes are analyzed by the milling particle gradation prediction model, so as to complete the prediction of recycled material gradation, and select a combination of operation parameters that meet the requirements of gradation for the in-situ cold recycling pavement construction.

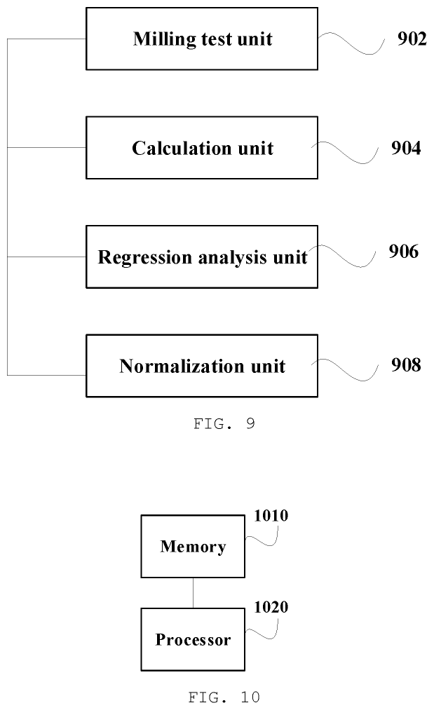

FIG. 9 is a block diagram illustrating a structure of a device for obtaining a milling particle gradation prediction model according to an embodiment of the present disclosure.

As shown in FIG. 9, the device comprises a milling test unit 902, a calculation unit 904, a regression analysis unit 906, and a normalization unit 908.

The milling test unit 902 is configured to sieve a plurality of groups of test particles obtained by a plurality of milling tests to obtain a sieve residual mass ratio corresponding to each of a plurality of sieves after performing the plurality of milling tests on an asphalt layer under a plurality of sets of test conditions, wherein each set of the plurality of sets of test conditions comprises: a rotational speed, a forward speed and a milling depth of a milling rotor of an in-situ cold recycling apparatus, the plurality of sieves having different aperture sizes.

The calculation unit 904 is configured to calculate a characteristic parameter of a cutting graph of the milling rotor according to arrangement of cutter teeth of the milling rotor, the rotational speed, the forward speed, and the milling depth.

The regression analysis unit 906 is configured to establish, by regression analysis, a functional relation between the sieve residual mass ratio corresponding to the each of the plurality of sieves obtained through a milling test and the characteristic parameter of the cutting graph of the milling rotor according to the rotational speed, the forward speed and the milling depth, wherein the sieve residual mass ratio corresponding to the each of the plurality of sieves is a function of the characteristic parameter of the cutting graph of the milling rotor.

The normalization unit 908 is configured to normalize the functional relation to obtain the milling particle gradation prediction model.

Thus, a device for obtaining a milling particle gradation prediction model according to some embodiments of the present disclosure is provided. The device can facilitate the prediction of recycled pavement particle gradation under different construction parameters, thereby solving as much as possible the problem existed in the related art that operation parameters can be determined by repeated tests on different road segments for in-situ cold recycling construction of an asphalt layer, so that a lot of manpower and material resources can be saved and the construction time can be shortened. In addition, the device may prevent, as far as possible, problems such as waste of asphalt layer material.

In some embodiments, the calculation unit 904 is configured to calculate a position of an xth cutter tooth of the milling rotor when the xth cutter tooth cuts to a maximum milling thickness according to the arrangement of the cutter tooth of the milling rotor, the rotational speed, the forward speed and the milling depth, wherein x is a positive integer and x >1, calculate an equation expression of a caving line corresponding to the xth cutter tooth according to the position of the xth cutter tooth of the milling rotor when the xth cutter tooth cuts to the maximum milling thickness and a caving angle of the xth cutter tooth when milling the asphalt layer, to obtain equation expressions of caving lines corresponding to a plurality of cutter teeth of the milling rotor, the plurality of cutter teeth comprising the xth cutter tooth, and calculate a characteristic parameter of a cutting unit pattern corresponding to the xth cutter tooth as the characteristic parameter of the cutting graph of the milling rotor according to the equation expressions of the caving lines corresponding to the plurality of cutter teeth of the milling rotor and the cutting graph of the milling rotor.

In some embodiments, coordinates of the position of the xth cutter tooth of the milling rotor when the xth cutter tooth cuts to the maximum milling thickness are (Lₓ, Pₓ), wherein Lₓ is an abscissa of the xth cutter tooth in the cutting graph in a direction parallel to an axis of the milling rotor, which is a known quantity, Pₓ is an ordinate of the xth cutter tooth in the cutting graph in a direction perpendicular to the axis of the milling rotor,

$${P}_{x} = ( \frac{{C}_{x}}{360} + m ) \frac{v}{n} sin ( θ ) ,$$

wherein

$$θ = arc cos \frac{R - H}{R} ,$$

wherein Cₓis a circumferential angle of the xth cutter tooth, v is the forward speed of the milling rotor, n is the rotational speed of the milling rotor, H is the milling depth, R is a milling radius of the milling rotor, and m is a number of an integer revolution that the xth cutter tooth has rotated, m 0 and m is an integer.

In some embodiments, the calculation unit 904 is configured to obtain equation expressions of a plurality of edges of the cutting unit pattern corresponding to the xth cutter tooth according to the equation expressions of the caving lines corresponding to the plurality of cutter teeth of the milling rotor, calculate position coordinates of a plurality of vertices of the cutting unit pattern corresponding to the xth cutter tooth according to the equation expressions of the plurality of edges of the cutting unit pattern corresponding to the xth cutter tooth, and calculate the characteristic parameter of the cutting unit pattern corresponding to the xth cutter tooth according to the position coordinates of the plurality of vertices.

In some embodiments, the characteristic parameter of the cutting unit pattern corresponding to the xth cutter tooth comprises: a length of a hypotenuse of a right triangle constructed inside the cutting unit pattern with one edge of the cutting unit pattern as a right angle edge in accordance with a predetermined composition method.

In some embodiments, the functional relation between the sieve residual mass ratio corresponding to the each of the plurality of sieves and the characteristic parameter of the cutting graph of the milling rotor is:

F_{φ}=A_{φ}(τ)³+B_{φ}(τ)²+C_{φ}(τ)+D_{φ},

wherein F_{φ} is the sieve residual mass ratio of a sieve φ, τ is the characteristic parameter of the cutting graph of the milling rotor, and A_{φ}, B_{φ}, C_{φ} and D_{φ} are coefficients.

In some embodiments, the normalization unit 908 is configured to calculate a theoretical value of the sieve residual mass ratio corresponding to each of the plurality of sieves according to the characteristic parameter of the cutting graph of the milling rotor and the functional relation, calculate a sum of theoretical values of sieve residual mass ratios corresponding to the plurality of sieves according to the theoretical value of the sieve residual mass ratio corresponding to the each of the plurality of sieves, and normalize the functional relation by using the sum of the theoretical values of the sieve residual mass ratios corresponding to the plurality of sieves.

The device for obtaining a milling particle gradation prediction model provided in an embodiment of the present disclosure can execute the method for obtaining a milling particle gradation prediction model provided in any embodiment of the present disclosure, which has function units and the beneficial effect corresponding to the method.

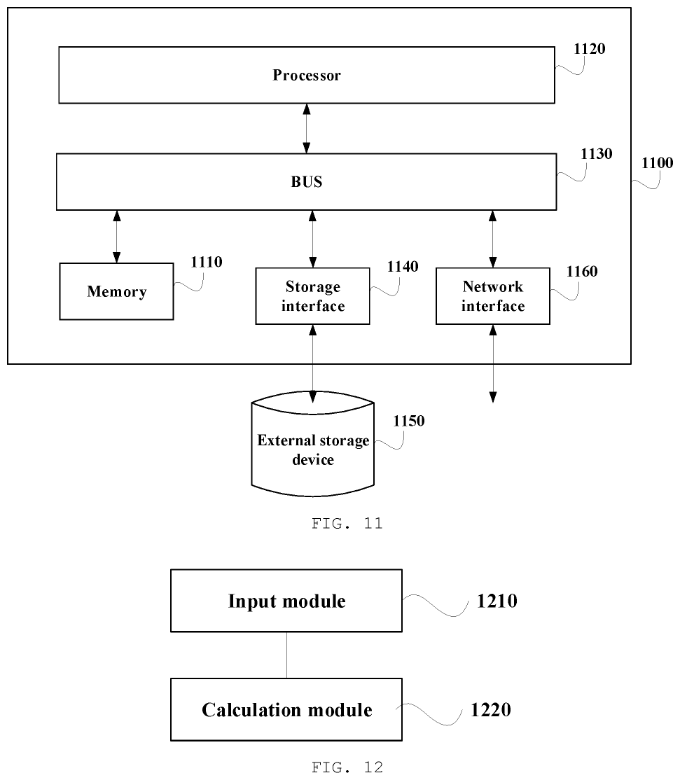

FIG. 10 is a block diagram illustrating a structure of a device for obtaining a milling particle gradation prediction model according to another embodiment of the present disclosure. The device comprises a memory 1010 and a processor 1020.

The memory 1010 may be a magnetic disk, flash memory or any other non-volatile storage medium. The memory is configured to store instructions of corresponding embodiment shown in FIG. 4.

The processor 1020 is coupled to memory 110 and may be implemented as one or more integrated circuits, such as a microprocessor or microcontroller. The processor 1020 is configured to carry out instructions stored in the memory to achieve prediction of particle gradation of recycled pavement material under different construction parameters and to reduce construction time.

In an embodiment, as illustrated in FIG. 11, a device 1100 for obtaining a milling particle gradation prediction model comprises a memory 1110 and a processor 1120. The processor 1120 is coupled to the memory 1110 via a bus 1130. The device 1100 may be further connected to an external storage device 1150 through a storage interface 1140 to access external data, and may be further connected to a network or another computer system (not shown) through a network interface 1160, which will not be described in detail.

In the embodiment, through storing data and instructions in the memory and processing the above instructions by the processor, prediction of particle gradation of recycled pavement material under different construction parameters is implemented to reduce construction time.

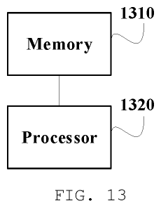

FIG. 12 is a block diagram illustrating a structure of a device for predicting recycled particle gradation according to an embodiment of the present disclosure. As shown in FIG. 12, the device comprises an input module 1210 and a calculation module 1220.

The input module 1210 is configured to input a condition parameter to a milling particle gradation prediction model. The milling particle gradation prediction model is obtained by the method described above.

In some embodiments, the condition parameter comprises: a rotational speed of a milling rotor and a forward speed of the milling rotor.

In some embodiments, the condition parameter further comprises a milling depth.

The calculation module 1220 is configured to calculate a sieve residual mass ratio corresponding to each sieve using the milling particle gradation prediction model and according to the condition parameter.

Heretofore, a device for predicting recycled particle gradation according to some embodiments of the present disclosure is provided. The device can achieve prediction of recycled pavement material gradation under different construction parameters, so that manpower and material resources required in the related technology can be saved and the construction time can be shortened. In addition, the device may prevent, as far as possible, problems such as waste of asphalt layer material.

The device for predicting recycled particle gradation provided in an embodiment of the present disclosure can execute the method for predicting recycled particle gradation provided in any embodiment of the present disclosure, which has function modules and the beneficial effect corresponding to the method.

FIG. 13 is a block diagram illustrating a structure of a device for predicting recycled particle gradation according to another embodiment of the present disclosure. The device comprises a memory 1310 and a processor 1320.

The memory 1310 may be a magnetic disk, flash memory or any other non-volatile storage medium. The memory is configured to store instructions of the embodiment corresponding to FIG. 8.

The processor 1320 is coupled to memory 1310, and may be implemented as one or more integrated circuits, such as a microprocessor or microcontroller. The processor 1320 is configured to execute instructions stored in the memory to achieve prediction of particle gradation of recycled pavement material under different construction parameters and to reduce construction time.

In some embodiments of the present disclosure, an in-situ cold recycling apparatus is further provided. The in-situ cold recycling apparatus comprises: the device for predicting the recycled particle gradation described above; and/or the milling rotor for the in-situ cold recycling apparatus described above.

In some embodiments, the present disclosure further provides a non-transitory computer-readable storage medium having computer program instructions stored thereon that, when executed by a processor, implement the method of the embodiment corresponding to FIG. 4 and/or FIG. 8. It should be understood by those skilled in the art that the embodiments of the present disclosure may be provided as a method, a device, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (comprising but not limited to disk storage, CD-ROM, optical storage device, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing apparatus to generate a machine such that the instructions executed by a processor of a computer or other programmable data processing apparatus to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture comprising instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

Heretofore, the present disclosure has been described in detail. In order to avoid obscuring the concepts of the present disclosure, some details known in the art are not described. According to the above description, those skilled in the art can understand how to implement the technical solutions disclosed herein.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

What is claimed is:

1. A method for obtaining a milling particle gradation prediction model, comprising:
sieving a plurality of groups of test particles obtained by a plurality of milling tests to obtain a sieve residual mass ratio corresponding to each of a plurality of sieves after performing the plurality of milling tests on an asphalt layer under a plurality of sets of test conditions, wherein each set of the plurality of sets of test conditions comprises: a rotational speed, a forward speed and a milling depth of a milling rotor of an in-situ cold recycling apparatus, the plurality of sieves having different aperture sizes;
calculating a characteristic parameter of a cutting graph of the milling rotor according to arrangement of cutter teeth of the milling rotor, the rotational speed, the forward speed, and the milling depth;
establishing, by regression analysis, a functional relation between the sieve residual mass ratio corresponding to the each of the plurality of sieves obtained through a milling test and the characteristic parameter of the cutting graph of the milling rotor according to the rotational speed, the forward speed and the milling depth, wherein the sieve residual mass ratio corresponding to the each of the plurality of sieves is a function of the characteristic parameter of the cutting graph of the milling rotor; and
normalizing the functional relation to obtain the milling particle gradation prediction model.

2. The method according to claim 1, wherein the calculating of the characteristic parameter of the cutting graph of the milling rotor according to the arrangement of the cutter teeth of the milling rotor, the rotational speed, the forward speed, and the milling depth comprises:
calculating a position of an xth cutter tooth of the milling rotor when the xth cutter tooth cuts to a maximum milling thickness according to the arrangement of the cutter tooth of the milling rotor, the rotational speed, the forward speed and the milling depth, wherein x is a positive integer and x >1;
calculating an equation expression of a caving line corresponding to the xth cutter tooth according to the position of the xth cutter tooth of the milling rotor when the xth cutter tooth cuts to the maximum milling thickness and a caving angle of the xth cutter tooth when milling the asphalt layer, to obtain equation expressions of caving lines corresponding to a plurality of cutter teeth of the milling rotor, the plurality of cutter teeth comprising the xth cutter tooth; and
calculating a characteristic parameter of a cutting unit pattern corresponding to the xth cutter tooth as the characteristic parameter of the cutting graph of the milling rotor according to the equation expressions of the caving lines corresponding to the plurality of cutter teeth of the milling rotor and the cutting graph of the milling rotor.

3. The method according to claim 2, wherein:
coordinates of the position of the xth cutter tooth of the milling rotor when the xth cutter tooth cuts to the maximum milling thickness are (Lₓ, Pₓ),wherein Lₓ is an abscissa of the xth cutter tooth in the cutting graph in a direction parallel to an axis of the milling rotor, which is a known quantity, Pₓ is an ordinate of the xth cutter tooth in the cutting graph in a direction perpendicular to the axis of the milling rotor,
$${P}_{x} = ( \frac{{C}_{x}}{360} + m ) \frac{v}{n} sin ( θ ) ,$$
wherein
$$θ = arc cos \frac{R - H}{R} ,$$
wherein Cₓ is a circumferential angle of the xth cutter tooth, v is the forward speed of the milling rotor, n is the rotational speed of the milling rotor, H is the milling depth, R is a milling radius of the milling rotor, and m is a number of an integer revolution that the xth cutter tooth has rotated, m 0 and m is an integer.

4. The method according to claim 3, wherein the calculating of the characteristic parameter of the cutting unit pattern corresponding to the xth cutter tooth according to the equation expressions of the caving lines corresponding to the plurality of cutter teeth of the milling rotor and the cutting graph of the milling rotor comprises:
obtaining equation expressions of a plurality of edges of the cutting unit pattern corresponding to the xth cutter tooth according to the equation expressions of the caving lines corresponding to the plurality of cutter teeth of the milling rotor;
calculating position coordinates of a plurality of vertices of the cutting unit pattern corresponding to the xth cutter tooth according to the equation expressions of the plurality of edges of the cutting unit pattern corresponding to the xth cutter tooth; and
calculating the characteristic parameter of the cutting unit pattern corresponding to the xth cutter tooth according to the position coordinates of the plurality of vertices.

5. The method according to claim 4, wherein the characteristic parameter of the cutting unit pattern corresponding to the xth cutter tooth comprises: a length of a hypotenuse of a right triangle constructed inside the cutting unit pattern with one edge of the cutting unit pattern as a right angle edge in accordance with a predetermined composition method.

6. The method according to claim 1, wherein the functional relation between the sieve residual mass ratio corresponding to the each of the plurality of sieves and the characteristic parameter of the cutting graph of the milling rotor is:
F_{φ}=A_{φ}(τ)³+B_{φ}(τ)²+C,(τ)+D_{φ},
wherein F_{φ} is the sieve residual mass ratio of a sieve φ, τ is the characteristic parameter of the cutting graph of the milling rotor, and A_{φ}, B_{φ}, C_{φ} and D_{φ} are coefficients.

7. The method according to claim 1, wherein the normalizing of the functional relation comprises:
calculating a theoretical value of the sieve residual mass ratio corresponding to each of the plurality of sieves according to the characteristic parameter of the cutting graph of the milling rotor and the functional relation;
calculating a sum of theoretical values of sieve residual mass ratios corresponding to the plurality of sieves according to the theoretical value of the sieve residual mass ratio corresponding to the each of the plurality of sieves; and
normalizing the functional relation by using the sum of the theoretical values of the sieve residual mass ratios corresponding to the plurality of sieves.

8. The method according to claim 1, wherein the milling rotor comprises:
a roller; and
multiple rows of cutter teeth spirally disposed on the roller, wherein the cutter teeth are arranged on the milling rotor in such a way that:
the multiple rows of cutter teeth comprise a plurality of cutter tooth sets arranged in a direction of an axial of the roller, wherein each of the plurality of cutter tooth sets comprises a first cutter tooth, a second cutter tooth and a third cutter tooth, the first cutter tooth, the second cutter tooth and the third cutter tooth being disposed in different rows of the multiple rows of cutter teeth, a projection of the second cutter tooth on the axis of the roller being between a projection of the first cutter tooth on the axis of the roller and a projection of the third cutter tooth on the axis of the roller, and a difference between a circumferential angle of the third cutter tooth and a circumferential angle of the first cutter tooth being less than a difference between a circumferential angle of the second cutter tooth and the circumferential angle of the first cutter tooth.

9. The method according to claim 8, wherein in a process of milling the asphalt layer by the milling rotor, the asphalt layer is cut in an order of the first cutter tooth, the third cutter tooth and the second cutter tooth.

10. A method for predicting recycled particle gradation, comprising:
inputting a condition parameter to a milling particle gradation prediction model, wherein the milling particle gradation prediction model is obtained by the method according to claim 1; and
calculating a sieve residual mass ratio corresponding to each sieve using the milling particle gradation prediction model and according to the condition parameter.

11. The method according to claim 10, wherein the condition parameter comprises the rotational speed of the milling rotor and the forward speed of the milling rotor.

12. The method according to claim 11, wherein the condition parameter further comprises the milling depth.

13. A device for obtaining a milling particle gradation prediction model, comprising:
a memory; and
a processor coupled to the memory, the processor being configured to, according to instructions stored in the memory, carry out the method according to claim 1.

14. A device for predicting recycled particle gradation, comprising:
a memory; and
a processor coupled to the memory, the processor being configured to, according to instructions stored in the memory, carry out the method according to claim 10.

15. A milling rotor for an in-situ cold recycling apparatus, comprising:
a roller; and
multiple rows of cutter teeth spirally disposed on the roller, the multiple rows of cutter teeth comprising a plurality of cutter tooth sets arranged in a direction of an axial of the roller;
wherein each of the plurality of cutter tooth sets comprises a first cutter tooth, a second cutter tooth and a third cutter tooth, the first cutter tooth, the second cutter tooth and the third cutter tooth being disposed in different rows of the multiple rows of cutter teeth, a projection of the second cutter tooth on the axis of the roller being between a projection of the first cutter tooth on the axis of the roller and a projection of the third cutter tooth on the axis of the roller, and a difference between a circumferential angle of the third cutter tooth and a circumferential angle of the first cutter tooth being less than a difference between a circumferential angle of the second cutter tooth and the circumferential angle of the first cutter tooth.

16. The milling rotor according to claim 15, wherein in a process of milling an asphalt layer by the milling rotor, the asphalt layer is cut in an order of the first cutter tooth, the third cutter tooth and the second cutter tooth.

17. The milling rotor according to claim 15, wherein a distance between adjacent cutter teeth in the direction of the axial of the roller is in a range of 16 millimeters to 22 millimeters.

18. An in-situ cold recycling apparatus, comprising:
the device for predicting the recycled particle gradation according to claim 14.

19. An in-situ cold recycling apparatus, comprising:
the milling rotor for the in-situ cold recycling apparatus according to claim 15.

20. A non-transitory computer-readable storage medium having computer program instructions stored thereon that, when executed by a processor, causes the processor to:
sieve a plurality of groups of test particles obtained by a plurality of milling tests to obtain a sieve residual mass ratio corresponding to each of a plurality of sieves after performing the plurality of milling tests on an asphalt layer under a plurality of sets of test conditions, wherein each set of the plurality of sets of test conditions comprises: a rotational speed, a forward speed and a milling depth of a milling rotor of an in-situ cold recycling apparatus, the plurality of sieves having different aperture sizes;
calculate a characteristic parameter of a cutting graph of the milling rotor according to arrangement of cutter teeth of the milling rotor, the rotational speed, the forward speed, and the milling depth;
establish, by regression analysis, a functional relation between the sieve residual mass ratio corresponding to the each of the plurality of sieves obtained through a milling test and the characteristic parameter of the cutting graph of the milling rotor according to the rotational speed, the forward speed and the milling depth, wherein the sieve residual mass ratio corresponding to the each of the plurality of sieves is a function of the characteristic parameter of the cutting graph of the milling rotor; and
normalize the functional relation to obtain the milling particle gradation prediction model.
